(19) United States
(12) Patent Application Publication
(10) Pub. No.: US 2008/0064467 A1
(43) Pub. Date: Mar. 13, 2008

(54) Methods and system for game playability and expectation wager payout

(76) Inventor: Martin Reiner, Chicago, IL (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 11/888,780

(22) Filed: Aug. 2, 2007

Related U.S. Application Data
(60) Provisional application No. 60/834,935, filed on Aug. 2, 2006.

(51) Int. Cl. A63F 9/24; A63F 1/00; A63F 13/10

(52) U.S. Cl. 463/16; 273/292; 463/25; 463/42

(57) ABSTRACT

A system and methods are presented for allowing single or multi-player interaction at multiple intermediate states between the initiation and conclusion states of a game of chance or skill. In certain embodiments, each player may choose to terminate their participation in the game at an intermediate state by accepting an early payout option. In another aspect of the invention, multiple players may participate in single version of a game, where a system keeps track of the individual decisions of each player and independently applies subsequent changes in game states to the decisions of each player.

### FIELD

The present invention relates generally to games of chance or skill. Specifically, the present invention relates to games having multiple states with calculable expected outcomes. The games may be implemented in an on-line gaming environment, or alternatively, in a traditional live face-to-face environment.

### BACKGROUND

One well known game having multiple states with calculable expected outcomes is Blackjack. In standard Blackjack, the player is dealt two cards face up and the dealer is dealt one card face up and another face down. As long as the player has 20 or less, he has the option to draw another card, trying to achieve a total hand score as close to 21 as possible, without going over (going over 21 may be referred to as a “bust” or “busting”).

The table 10 in FIG. 1 shows all 350 possible combinations of player/dealer cards immediately following the deal and their associated positive or negative expected value. Cells shaded lightly are hands with positive expected values and the rest, shaded darkly, have negative expected values. While some hands share the same expected values (positive or negative) most of these combinations are different, ranging from very good hands (high expected values) to very poor hands (low expected values).

After the player concludes his turn, the dealer plays his hand by casino rules, in this case, hitting until he reaches 17 or higher, then standing. After the dealer has concluded, one of the following payouts/outcomes will occur:
i. If the player busts on his turn, he loses his entire bet
ii. If the player stands, then the outcome is determined based on the dealer's hand:
   1. If the dealer busts, the player wins (1:1 payout)
   2. If the dealer's hand exceeds the players hand in point value, the player loses his entire bet
   3. If the dealer's hand equals the players hand in point value, the hand is considered a “push” and the player is returned his wager

These basic rules for Blackjack have been adapted for on-line game play. There are, however, disadvantages to the basic rules Blackjack. For example, the potential outcomes from the player's perspective are limited to a win, a loss or a tie (“push”). In addition, the dealer, house, or casino has a fixed or pre-determined statistical “edge” or advantage. Blackjack is also typically limited from an operations perspective, in terms of participation, to a limited number of players that can physically sit at a traditional Blackjack table (typically up to 7 players). Other casino games face similar disadvantages. It would therefore be desirable to have an improved gaming system and method that may address one or more of these disadvantages/limitations arising in known games, such as Blackjack.

### BRIEF DESCRIPTION OF THE DRAWINGS

The presently preferred embodiments of the invention are described below in conjunction with the appended figures, wherein like reference numerals refer to like elements in the various figures, and wherein:

FIG. 1 is a table illustrating positive and negative expected values of the various combinations of player and dealer cards following an initial deal in Blackjack;

FIGS. 2A and 3A illustrate examples of a Blackjack game state following the initial deal in accordance with one embodiment, where the game state includes an offer of an early payout amount;

FIGS. 2B and 3B illustrate examples of Blackjack game states in accordance with another embodiment, where the game states include early payout, the game is dealt by a dealer that is shown on a game client, and a timer is illustrated;

FIG. 4 is a schematic drawing of one embodiment of a system in which the gaming methods described herein may be implemented;

FIG. 5 illustrates a game table according to an embodiment in which a touch screen monitor is provided at each player position and another monitor is provided at the dealer position;

FIG. 6 is a collection of screen shots from the dealer monitor in one embodiment, where the screen shots illustrate functions performed by the dealer monitor;

FIG. 7 shows an initial deal for Texas Hold'em Bonus with Early Payout in accordance with a preferred embodiment; and

FIG. 8 shows the game of FIG. 7 at a later game state, i.e. after the flop.

### DETAILED DESCRIPTION OF THE PRESENTLY PREFERRED EMBODIMENTS

Preferred embodiments provide a system and method for player interaction at multiple intermediate states between the initiation and conclusion states, inclusive, of a game of chance or skill, where the player may choose to terminate the game at an intermediate state by accepting an early payout option. In this case, the player forfeits his initial wager (and possibly subsequent wagers), ceases his participation in the game, and collects the value of the early payout. In other preferred embodiments, a traditional game is modified to allow more than one participant in a single player hand or at a single game position.

The preferred embodiments may be implemented in a variety of ways, including in an on-line gaming environment and live face-to-face gaming environments. On-line gaming environments, which are well known, are typically accessed by users via personal computers, workstations or kiosks and the like that are connected by publicly accessible networks, such as the Internet, to a source server or set of source servers (which may be referred to herein as a “game server”). In another preferred embodiment, a game of chance or skill is presented in the form of a live face-to-face casino game. For example, a Blackjack game may include a live dealer, who is shuffling and dealing real cards onto a traditional Blackjack table. Known hardware, such as an (optional) video camera and automated card scanner, game control units, dealer instruction monitors, player game monitors (game clients) may be integrated to the source server(s) directly, for example via Local Area Network (LAN), to adapt the action at the live table to the be very similar to that of the on-line environment. The main difference is that the communication between the card scanners, the game control unit, the game servers and the game client (running the player interface) may be done at a physically local live environment (such as, for example, a traditional casino), while these components may be located in multiple locations connected via internet, wide area network (WAN), LAN, wi-fi (wireless), or other data communication networks for remote or on-line applications. In this case, the methods described below may be implemented as a set of instructions, or program code, that runs on the server(s)/client(s) connected by the data communication network that is suited for the specific application. Alternatively, the preferred embodiments may be implemented using smart gaming tables, i.e. gaming tables that include basic processor, memory, user interface, and automated card scanner functionality, such as one may find in a casino, or in the home environment, such as by program code for a personal computer, or a processor-based game. In a preferred face-to-face embodiment, the player positions at the smart gaming table are provided access to a user interface, such as for example a touch screen monitor, for presenting the player with options and receiving player decisions. Other types of user interfaces may alternatively be used. As one option, each player position in this face-to-face embodiment may include such a user interface. In regard to the basic processor, the smart table or any grouping of smart tables may include a game server and one or more game clients. Game play may then proceed in the same manner as in the on-line environment, as described further below.

In the on-line environment, the game client would typically reside on the player's computer, but may alternatively reside in any location accessible to the player via network connection. Basically, the live environment may be identical to the online environment—e.g., scanners, dealer monitor, player monitors, game control units—but the live embodiments may be networked by wired or wireless LAN (i.e. not using the internet); whereas the on-line version may utilize the internet, and, in an on-line version, the dealer action (video and audio) may be communicated to the player/client by using video and audio streaming technology alongside all the common game control elements.

Early Payout

One preferred method involves initiating a game of chance or skill, or setting the initial state of the game. Initiating the game may involve presenting the player with an opportunity to place an initial wager. At this point, the expected value of the wager may or may not be known. Of course, in a casino setting, the (negative) expected value of the initial wager is typically known—referred to as the house advantage for the particular game. In other embodiments, the opportunity for the player to place an initial wager may occur when a game of chance is already in progress, and the expected value of the wager can be determined either mathematically or by statistical methods such as Monte Carlo simulation. The phrase expectation wager payout refers to a payout that is related in some manner to the expected value of the wager.

After the player has placed an initial wager, the game may continue to an intermediate state. This continuation may involve the dealing of additional cards, the rolling of a die or dice, or the electronic equivalent of such activity, such as via Random Number Generator (RNG) algorithms or hardware. More generally, each action that affects the expected value of the player's initial wager (or subsequent wagers in more complex games) may be considered an action that progresses the game to a next intermediate state. Each intermediate state is characterized as providing a specific expected value of the player's bet and the player may be presented with a decision before the game proceeds to the next state. For example, in one Blackjack implementation, the player may be presented with a decision, such as an early payout option, at every intermediate state. In other embodiments, however, it is not necessary that the player be provided with an early payout option at each intermediate state. After the game continues to a next intermediate state, the expected value of the player's initial wager may or may not have changed. Regardless, according to certain embodiments of the invention, the player is presented with an early payout option.

The early payout option permits the player to exit the game by accepting an early payout. By accepting the early payout, the player terminates his participation in the game. Alternatively, if the player does not opt for the early payout, the player continues playing the game, for example without any change to the standard game rules. Early payout is an extra feature or option offered to the player. In an embodiment of the invention, the value of the early payout is based upon the value of the player's initial wager, the current expected value of the wager at the intermediate state, and possibly any number of associated values. In one embodiment, the early payout option may be the normalized expected value of the wager multiplied by the player's initial wager. In another embodiment, the early payout option may be the normalized expected value of the wager multiplied by the player's initial wager multiplied by the value of one minus a house percentage, or:
N×I×(1−P)
where N is the normalized expected value of the wager and is greater than 1, I is the initial wager of the player which is greater than 1, and P is the house percentage where:
0≦P≦1

In another embodiment, any of the above embodiments may involve adjusting the early payout value by a modest amount for playability. For example, if an above calculation yields a value of 7.059, the actual early payout value may be adjusted for playability to 7, 7.1, 7.06, or 7.05. In part, adjusting for playability permits the player to receive the early payout in manageable increments. Alternatively, other methods may be utilized to determine the early payout value.

The normalized expected value of a wager at a current state may be determined through several methods. In one embodiment, the normalized expected value of the wager may be determined via a lookup table, where the various normalized expected values of various game states are stored in the table, and the value is determined by retrieving the value associated with a current game state. The normalized expected values of the various game states stored in the table may be generated by Monte Carlo simulation. Alternatively, the normalized expected values of the various game states stored in the table may be generated by determining all future possible game states and determining the amount of an initial wager that a player will win at a given state. In any event, the normalized expected values may be maintained and/or determined at the game server.

In another embodiment, where the outcome of the game is bimodal (either the player loses his initial wager or the player wins an amount proportional to the initial wager) the normalized expected value of the wager may be determined by calculating all future possible states and multiplying the probability that the player will win by the amount that he will win. For example, in a game where the player places an initial bet of 10 and the outcome of the game is such that a player either loses his initial wager or wins 11, then the expected value of the wager is determined by calculating all future states to determine the probability that a player will win and then multiplying that probability by 11. In addition, this expected value of the wager can be normalized to a value of 1.1, and applied generally to initial bets of differing values. In another embodiment, the normalized expected value of a game state may be calculated by a general mathematical function. Alternatively, any combination of the above methods or other methods may be utilized to determine the normalized expected value of a wager at a given state.

As noted above, in general if the player accepts the early payout option, then he receives the value of the early payout and ceases his participation in the game. However, in the case of complex games where there may be multiple game threads in existence or where there may be multiple bets locked into the outcome of a future event (such as craps), the player may collect on an early payout option without ending participation in the game. More specifically, the player may collect an early payout in exchange for a bet that could he could not ordinarily remove from play, but may continue participating in the game via other laid bets. For example, but without limiting to such an example, according to an embodiment of the invention, in the game of craps where a point has already been rolled, if a player lays a come bet and the shooter rolls a come point (a 4, 5, 6, 8, 9 or 10) the player may be able to accept an early payout bet for his come bet (which is tied to the respective come point), but remain a player in the overall game with respect to any other bets.

In addition, it is not required, but is an option, that a player is presented with an early payout option at every intermediate state. The controller of the game may selectively choose to present the player with an early payout option based upon various factors, including the value of the early payout, the normalized expected payout of the hand (such as whether the expected payout is more or less than or equal to the initial wager). Deciding whether to present the player with an early payout option may also be based upon various characteristics of the game itself, and whether presenting the early payout option might either improve or interfere with the playability of the game.

In another embodiment, the player may have only a limited amount of time to select an early payout option, after which the player may forfeit a chance to collect an early payout and is required to continue playing the game. Alternatively, in another embodiment, after the limited amount of time has expired the player may default into accepting the early payout option and terminating his participation in the game. In yet other embodiments, the player has a choice to configure his default settings to either accept or decline early payout when a timer has expired.

Blackjack with Early Payout

In one implementation of the preferred embodiments, early payout may be applied to the standard game of Blackjack. In standard Blackjack, the rules of which are generally known in the art and are described above, the player places an initial bet and is then dealt two cards face up, while the dealer is dealt one card face up and one card face down. For the player, the goal of the game is to beat the dealer, generally by acquiring cards having a combined total as close to 21 as possible. To this end, as long as the player's cards total less than 21, the player generally has the option of drawing another card. Alternatively, the player may have other more complex options, such as splitting two equal-valued cards after the initial deal, or doubling down following the initial bet in exchange for only one additional dealt card. Once the player has concluded his turn, either by standing or busting (acquiring cards having a combined total in excess of 21) the dealer generally plays his hand by casino rules, or dealing until his cards have a combined value of 17 or higher, and then standing. If the player has busted, he forfeits his entire bet. If the player has not busted, then the outcome is determined as follows: the player wins if the dealer busts, or the player's hand is greater than the dealer's hand; the player loses if the dealer's hand is greater than the player's hand; and the player's bet is returned if the player's hand equals the dealer's hand.

In an early payout version of Blackjack, or Blackjack with early payout, the player is offered the option of collecting an early payout at various game states, as illustrated below. The initial state of the Blackjack game occurs after the player initiates play by laying an initial bet. At this point, although the odds are calculable and the expected value of the player's bet can be determined, it is not generally required that the player be presented with an early payout option. However, it is conceivable and possible to provide early payout at this initial stage.

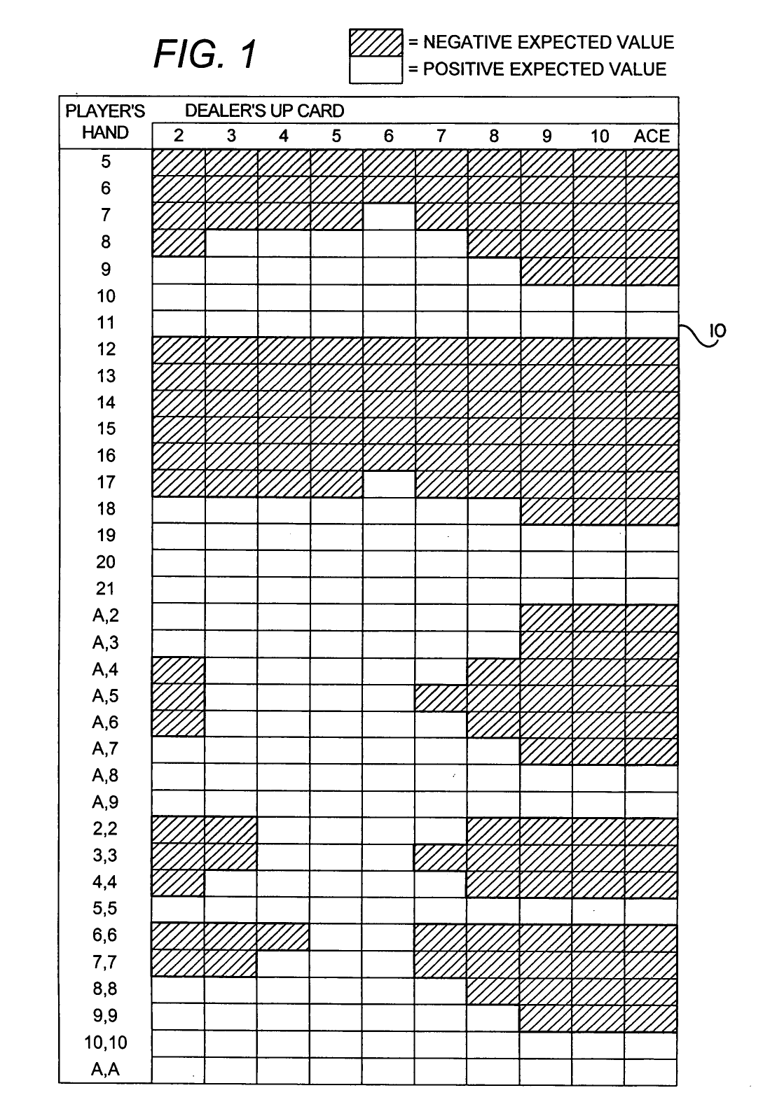

After the player has laid an initial bet, the dealer deals two cards to each player and two to the dealer, one ‘up’ (showing) and one ‘down’ (hidden), and the game progresses to an intermediate state. Alternatively, in ‘European’ rules Blackjack, the dealer may only deal himself one ‘up’ card and take the rest of his cards after the players are finished. FIG. 1 shows all 350 possible combinations of player/dealer cards immediately following this initial deal for a single player and a dealer. Cells in light gray indicate those combinations where the player's initial bet has a positive expected value, while cells in dark gray indicate those combinations where the player's initial bet has a negative expected value. Each combination has a different expected value, which may vary from very good hands for the player (combinations having very high expected values) to very poor hands for the player (combinations having very low expected values). As noted above, the expected values for each of the combinations may be generated or calculated, and then stored for future use.

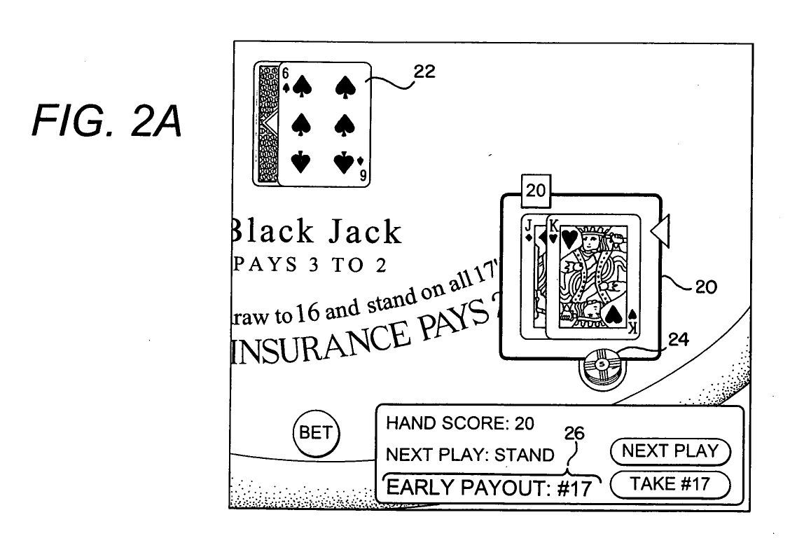

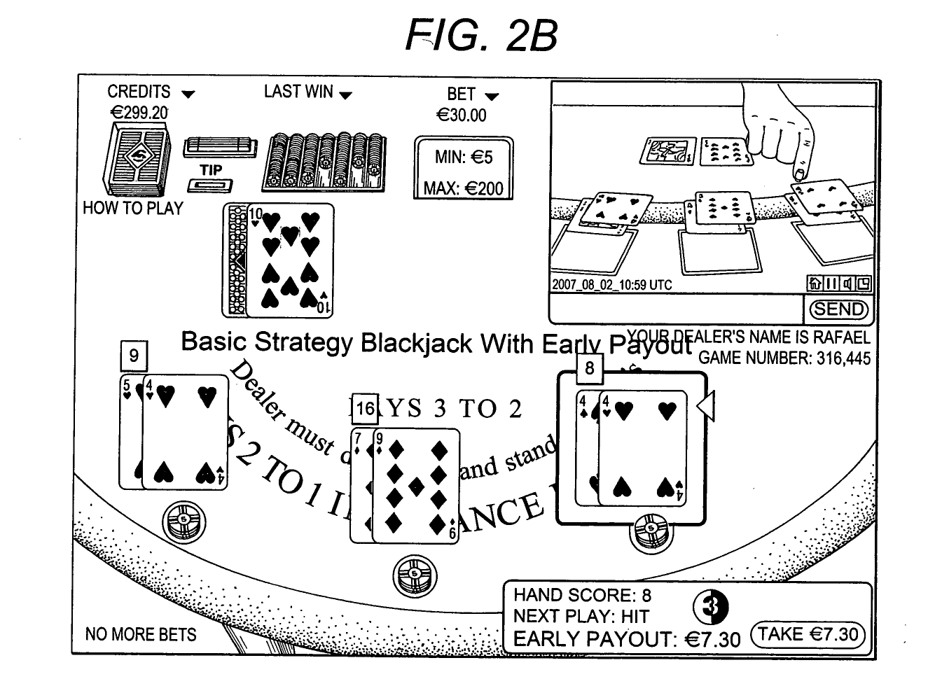

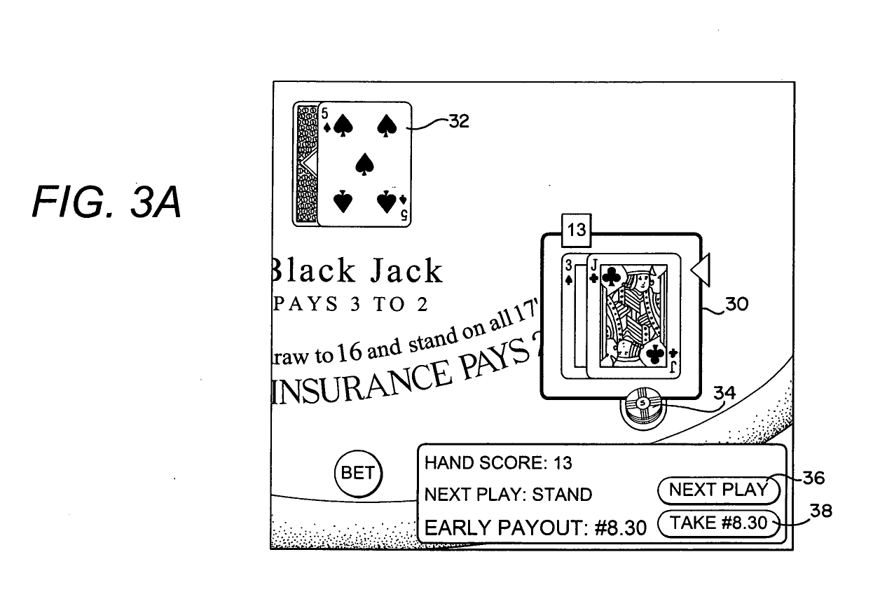

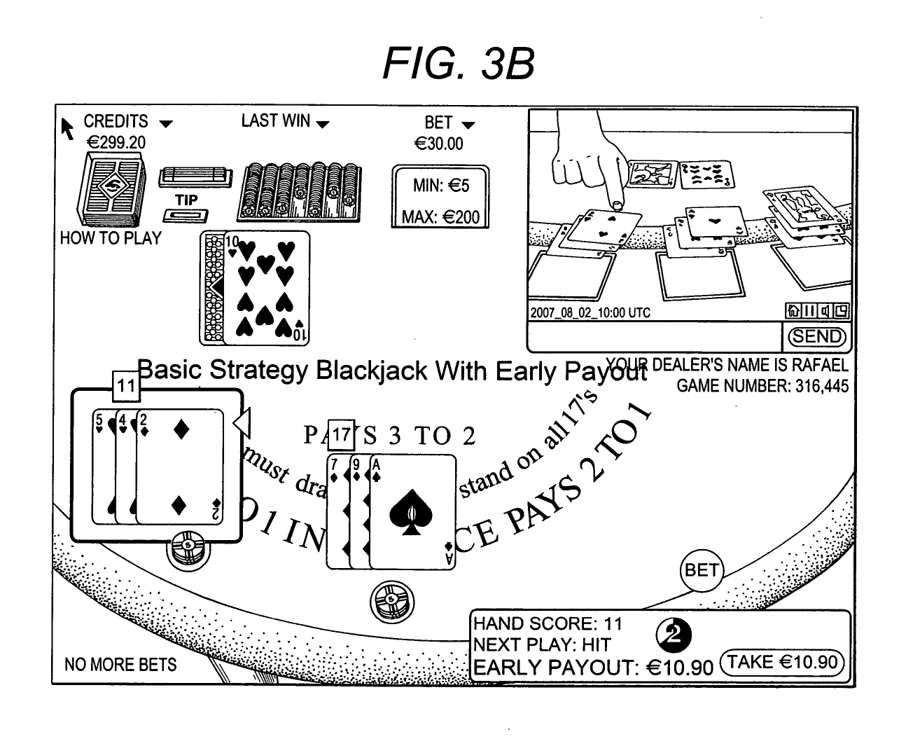

After the initial deal, based upon the current combination of cards, the expected value of the player's initial bet may be determined and used to generate an early payout value, as described above. This early payout value is then presented to the player as an early payout option. FIGS. 2A and 3A illustrate examples of a Blackjack game following the initial deal. In FIG. 2A, the player position 20 has been dealt a Jack and a King, giving it a total hand value of 20. The dealer position 22 is showing a 6. Based on this combination of player and dealer hands, the player's initial bet 24 of 10 units has been calculated as having an early payout value 26 of 17 units. That the early payout value 26 is greater than the player's initial bet 24 is in agreement with the table of FIG. 1, which shows that a player's hand of 20 with a dealer showing a 6 corresponds to a positive expected value. As illustrated in FIG. 2A, the early payout value 26 is offered to the player, and the player may be given the option of hitting, standing, or accepting the early payout value (and thereby taking the early payout option). In the embodiment shown in FIG. 2A, the player is offered a choice between continuing to play the hand according to an optimal choice playing strategy, described further below, indicated as “Next Play,” and taking an alternative position, in this case early payout of #17. If the player accepts the early payout option, such as by clicking on “Take #17,” he collects the early payout value and that player's participation in the current hand ends.

If the player opts to continue playing (and forgoes the early payout option), e.g., by clicking on “NEXT PLAY,” then play continues as per normal Blackjack rules and, in this embodiment, early payout options are provided to the player at each subsequent game state, including each time he is given the opportunity to hit/stand, etc. If the player decides to hit, a new card will be dealt to the player's hand. At this point, a new early payout value may be determined, and (regardless of whether or not the new early payout value is different from the previous one) may be presented to the player as an early payout option. According to an embodiment, this iteration of presenting the player with an early payout option when deciding whether (amongst other possible options) to hit or stand continues until the player either stands or busts, or otherwise plays his hand until conclusion via normal Blackjack rules.

As noted generally above, this implementation may be applied to either the on-line environment or a face-to-face game situation. Further details on an on-line implementation are provided below.

In this embodiment, as long as the player has a hand valued at 21 or less (he hasn't busted), the player is offered an additional choice: Take Early Payout of $xx.xx amount. See graphical examples in FIGS. 2A and B and 3A and B. If the player elects to take Early Payout, he no longer has any risk exposure to any subsequent cards that are dealt, because he has elected to end the hand early. The Early Payout value that an online casino will offer the player may be a function of the expected value of the hand and the size of the players wagers, less a ‘house edge’, typically 1-5%. If the player elects not to take early payout, and draws another card without going over 21, he is offered a new Early Payout amount, based on the new value of the hand (either better or worse than it was previously). This iteration continues until the player busts or stands and elects not to take Early Payout (i.e. plays the hand to its conclusion, per normal Blackjack).

In the following example, further details are provided to illustrate the Player's choice in Early Payout Blackjack, where the Player's hand has a Positive Expected Value, as identified for example in FIG. 1. In the hand below, the player has been dealt a 20 versus a dealer card 6. The Player's wager is 10 units. This is the game situation illustrated in FIG. 2A. The player's choice here is either to:
a) Continue to play the hand as he would in Standard Blackjack (Stand)
   a. Possible outcomes include Winning (receive 20 credits, losing receive 0 credits or pushing receive 10 credits); or
b) Take Early Payout and immediately end the hand for the Player.
   a. Outcome determined: Player receives 17 credits (profit of 7), regardless of what happens with the dealer hand.
      In other words, the Player is presented with an additional decision point, prior to the completion of the dealing of the hand. At this decision point, the player is offered a guaranteed gain (for hands having a positive expected value), ending the hand for that Player.

In the next example, further details are provided to illustrate the Player's options in Early Payout Blackjack, where the Player's hand has a Negative Expected Value. In the hand illustrated in FIG. 3A, the player position 30 has been dealt a 13 (hand score) versus a dealer card 32 of 5. The Player's wager 34 is 10 credits. His choice here is either to:
c) Continue to play the hand as he would in Standard Blackjack (Stand)—i.e. “NEXT PLAY” 36
   a. Possible outcomes include Winning (receive 20 credits, losing receive 0 credits or pushing received 10 credits)
d) Take Early Payout and immediately and end the hand—i.e. “TAKE #8.30” 38.
   a. Outcome determined: Player receives 8.30 credits (loss of 1.70), regardless of what happens with the dealer hand.

FIGS. 2B and 3B illustrate examples of Blackjack game states in accordance with another embodiment, where the game states include early payout, the game is dealt by a dealer that is shown on a game client, and a timer is illustrated. In this embodiment, the game client presents the player(s) with a choice of taking Early Payout, e.g. by clicking the “TAKE 7.30” button in FIG. 2B and the “Take 10.90” button in FIG. 3B. Rather than presenting the player(s) with a Next Play button, as shown in FIGS. 2A and 2B, this embodiment utilizes a countdown timer that is illustrated to the player(s) in the box in the lower right-hand corner. The player(s) is advised, as illustrated in the box in the lower right-hand corner, of the “next play.” In FIG. 2B, the player has 3 seconds to click the “Take 7.30” or the dealer will proceed with the recommended next play, hit, as illustrated. In FIG. 3B, the player has 2 seconds remaining to take Early Payout, as illustrated in the lower right-hand corner, or the dealer will proceed with the next play, hit. In FIGS. 2B and 3B, the active hand is designated by surrounding the hand with a box with a pointer, preferably of a bright color.

As illustrated in the examples above, a preferred embodiment enhances the standard Blackjack game by incorporating one or more additional decision points, and associated payouts. This embodiment, as noted above, may be implemented in an on-line gaming environment or in face-to-face gaming applications. It should be noted that Early Payout is not limited to applications in connection with the game of Blackjack, but rather may be implemented by those skilled in the art upon reading this detailed description, in other gaming applications. For example, and without limitation, Early Payout may be applied to other casino games as follows:

| Game | When Early Payout (“EP”) May Apply |
|---|---|
| Blackjack | On each player's turn prior to going over 21 |
| Craps | After the player has made his ‘Point’, he could |
| | elect to take EP to end the roll and ‘Come Out’ |
| | again. In this game, all EPs are a loss (negative |
| | expected values) |
| Texas Hold'em Bonus | At each stage of the game prior to it's conclusion |
| (or other casino | in which the player has a decision (after the deal, |
| poker game) | after the flop, after the turn, after the river), the |
| | player could elect to take EP (full spectrum of |
| | positive and negative expected values) |
| Baccarat/Punto Banco | Provided that neither the player or the banker has |
| | a ‘natural’, the player could elect EP before more |
| | cards are dealt |

Basic Strategy Blackjack

In a modified version of Blackjack, referred to herein as Basic Strategy Blackjack (BSBJ), the basic rubric of standard Blackjack is kept, but the choices presented to the player are slightly altered, more closely resembling the actions that a professional Blackjack player would likely choose to take. In BSBJ, the initial deal and payouts of standard Blackjack are the same; however the decision as to whether to hit, stand, split, double, etc. is removed from the player's control. Rather, the decision to hit, stand, split, double, etc. is made based upon the choice that has the greatest theoretical advantage to the player. As a result, the player is provided with an ability to control aspects of his bet when appropriate whether to double, or whether to play both hands in a split); however the player does not decide how his hand is dealt. Instead, the hand is dealt according to well-defined rules that will maximize the odds (minimize the casino's house advantage) for the hand at the player's position. In this regard, Basic Strategy Blackjack may be considered to be more fair, in the sense of leveling the playing field, because it eliminates an important difference between novice players and expert players.

For instance, when a player is dealt two cards that total 11, it is generally to the player's advantage to double (except vs dealer Ace). As a result, in BSBJ, when the player is dealt initially dealt two cards that total 11, the player position will automatically receive another card (i.e. the hand will be dealt according to Basic Strategy rules). Similarly for each other stage of the game following the initial deal, where the player would normally decide whether to stand or take other action, this decision is made for the player based upon the theoretical “best” or “optimal choice,” or Basic Strategy rules.

Determining the “best” or “optimal choice” according to Basic Strategy rules involves determining which move will maximize the player's odds at each intermediate state. Finding which move will maximize the player's odds may be determined by running Monte Carlo simulations to determine the expected values of all the possible next intermediate states, and then determining the probability of each of the next intermediate states. This information can then be used to determine which action will have the highest average expected value, and therefore which action will dictate the manner in which the player's hand is dealt. Because of the complexity in determining the next move in accordance with Basic Strategy rules, lookup tables may be maintained to store the best moves for all possible player/dealer hand combinations. Alternatively, calculations for determining the next move in BSBJ may be carried out in real-time during game play via a computing system.

Because the decision to stand/hit/split/double is already made for the player, in BSBJ the player chooses instead whether to continue playing his bet (or increase his bet in the case of splits or doubling) in accordance with each decision; rather than deciding the course of his hand, the player is told which move will be made on his behalf and is then given a choice to either “follow” the move, or decline the move or additional bet. Examples of this type of decision are presented in FIGS. 2 and 3, where the player is not required to select among the more numerous conventional potential choices of hit, stand, double, etc., but rather is presented with a different choice, Next Play or Take Early Payout.

For purposes of explanation and without limiting the invention as such, in one example, if the player is initially dealt a five and a seven (for a total hand value of twelve) and the dealer has a nine showing, the player will be told that his hand will be hit (according to Basic Strategy rules); the player will then be presented with the choice of either standing, or following the course of play that has been decided for him (in this case, having his hand hit). If the player chooses to stand, then his initial bet will be locked in to the current hand of twelve, and any subsequent changes to the cards at the player's position (i.e. additional cards dealt to the player's position) will not affect his hand. If the player chooses instead to follow Basic Strategy (and therefore to hit), then the next dealt card will affect the outcome of the player's initial wager. In a preferred embodiment, the hand is dealt to the player's position in accordance with Basic Strategy regardless of the player's decisions, but additional cards only affect the player's outcome to the extent that the player chooses to follow Basic Strategy.

Based on this additional card, the player will again be told the next course of action according to Basic Strategy rules, and will again be given the option to follow the recommended Basic Strategy course of action, to stay with his current hand and bet. This iteration continues until the player either decides to stand (and therefore to not follow the next course of action), or the next course of action based on Basic Strategy is actually to stand. As stated above, however, regardless of the player's decisions regarding his wager in BSBJ, the hand will always be dealt according to the rules of Basic Strategy.

In addition to the simple HIT or STAND decision, Basic Strategy also includes more complex decisions including SPLIT and DOUBLE. In the case of SPLIT and DOUBLE, where the player may have the option to increase his wager, a player may be presented with the option NOT to play BOTH HANDS of SPLIT or NOT to DOUBLE his wager. The wagering (or not) decision of the player does not affect how the cards will be dealt (i.e. for splits, the hands will be split into two hands (although the player may only play the first one; and for doubles, only one card will be dealt to the hand and then it must stand, regardless of whether the player elected to double his wager or not)

For example, if the move that optimizes a player's odds with a given hand is to split the hand, the player may have the option of only playing the first hand, and not placing an additional wager for the second hand. If the player opts to only play the first hand, then both hands will continue to be played according to Basic Strategy rules, but the player's initial wager will be tied solely to the first hand.

In another example, if the move that optimizes a player's odds is to double, the player may be given the option of following the Basic Strategy move of doubling his wager, or remaining with his initial wager In accordance with this embodiment of the invention, regardless of whether the player chooses to double his bet or not, the dealer will only deal a single additional card. Therefore, the player is presented with the option of playing with only his initial bet, or with double his initial bet.

One significant advantage of Basic Strategy-type games, such as BSBJ described above, in addition to providing players with a learning tool to understand basic strategies and probabilities in the game, is that it permits multiple players to participate in a single player hand without necessarily having the same wagering outcome if some elect not to follow the course of Basic Strategy at various different states in the game. Because the decision as to the next course of action is decided by probabilities embodied within Basic Blackjack Strategy, and therefore the hand is only dealt in one way regardless of each player's decision, each player can act independently at each stage of the hand in deciding whether or not to follow each course of action, and in deciding how to manage his own wager. As a result, the invention may be utilized in conjunction with an invention in accordance with International Application Number PCT/GB01/042277, entitled “A Gambling Apparatus and Method of Monitoring a Gambling Event” and incorporated in its entirety by reference herein, in order to monitor a live hand of Blackjack and permit multiple players to participate according to the rules of BSBJ, or BSBJ with early payout, or generalized variations thereof as described below.

Notably, in the Basic Strategy-type game described herein, including BSBJ, the hand is always dealt in the same manner regardless of what any particular player actually does during the course of the deal. In other words, the dealer always proceeds to deal the hand according to Basic Strategy. The player, on the other hand, may or may not follow the Basic Strategy. Of course, although described in connection with Blackjack, the Basic Strategy method of play may also be adapted to other games of chance or skill. This Basic Strategy method of play provides significant advantages in, for example, the on-line environment. Specifically, one significant advantage provided by the Basic Strategy method is that it allows multiple players to occupy the same game “position” (e.g.,. play the same cards/hand) where each player may make his or her own game decisions while the dealer continues to deal according to Basic Strategy.

Early Payout is a powerful feature that makes BSBJ work in practice, because it offers a viable and fair way to decline following Basic Strategy but instead to take the “payout.” This principal applies to other games such as Texas Hold'em Poker (vs casino) where the dealer deals the hand to completion regardless of the wagering decisions of the player (ie multiple players can make different decisions/have multiple outcomes vs. the same dealt hand), described further below. Early payout is one potential choice that may be offered—but there may alternatively be others (e.g., don't buy the card, don't bet on the flop, etc.)

Basic Strategy Blackjack with Early Payout

In another embodiment of the invention, the offer of early payout is combined with a Basic Strategy-type game, such as BSBJ. More specifically, in the example of BSBJ, instead of providing the player with the option of either standing (and maintaining his original bet with the current player hand) or progressing with the recommended action, the player is instead presented with the option of progressing with the recommended action or collecting an early payout. This preferred embodiment may be termed Basic Strategy Blackjack with Early Payout (BSBJEP).

This provides the advantage of substantially speeding up game play by eliminating, for example, one or more of the player decisions of whether to HIT/STAND/DOUBLE/SPLIT, etc., and replacing that with automated dealing rules that follow Basic Strategy. Basic Strategy is a method of playing Standard Blackjack whereby the player decisions (Hit/Stand, etc) follows a set of pre-calculated ‘optimal actions’ for any player hand vs. any dealer card shown. A player following Basic Strategy therefore statistically maximizes his potential return versus any other possible play actions. A “Basic Strategy-type” game, as that term is used herein, is a game in which pre-calculated “best” or “optimal choices” for any potential player hand may be determined and the ‘next move’ recommended and/or automated by the game server.

In BSBJEP, the basic rules and payouts of Standard Blackjack apply. The initial deal of the game is the same, two visible cards to the player position(s), one ‘up card’ for the dealer. From this point, the game deviates from the standard game as described below. While in a normal game of BJ, the player can decide whether to HIT/STAND/Double, etc., with BSBJEP, the player is given a different fundamental choice: whether to continue with the “Next Play” per the predetermined matrix referred to as Basic Strategy OR whether to Take Early Payout. He does NOT have the option to deviate from the Basic Strategy play (which would not theoretically be to his advantage anyway).

For example, if the player wagers $10 and is dealt a 9 and 5 (total 14) and the dealer is dealt a 10, Basic Strategy would require that the player take a card (HIT). This is not a strong hand for the player (negative expected value), but by following Basic Strategy, the expected value of the play will be maximized (less negative in this case).

In BSBJEP, the player will be told what the Next Play will be and also be given the opportunity to exit the hand early by taking Early Payout instead of proceeding with the Next Play. In the above example, Next Play would be HIT and Early Payout might be $5.80. If the player selects Next Play, his hand will either improve or worsen, depending on the next card. If the player elects to Take Early Payout, his risk ends immediately (in the above example, locking in a loss of $4.20 ($10−5.80). Each time the player elects Next Play, he remains active in the outcome of the hand. Each Next Play continues to be determined by Basic Strategy (not the player). As long as the hand remains 21 or less (has not Busted), the player will continue to have the option to continue playing the hand further to its standard conclusion or Take Early Payout, as each new card dealt changes the game state for better or for worse.

Continuing with the above example:
Possible outcome 1: if the player whose hand totals 14 against a dealer up card of 10 elects Next Play and he is dealt a 6 (new total=20), he will have increased his likelihood of winning the hand. Having reached 20, his Next Play=Stand (per Basic Strategy) and his Early Payout Value increased, for example, to $15.10. The player can either continue with the hand to its conclusion (this is the last opportunity he has for Early Payout) or take Early Payout. If he takes Early Payout, he will lock in a win of $5.10 (15.10−10). If the player continues with the game, he will either win (10), push (0) or lose (−10) as with the standard game, depending on the final dealer result.
Possible outcome 2: if the player whose hand totals 14 against a dealer 10 elects Next Play and he is dealt a 2 (new total=16), he will have slightly decreased his likelihood of winning the hand. Having reached 16, the player's Next Play=HIT and his Early Payout Value may have decreased to $4.80. Again, he can elect to follow the Next Play (per Basic Strategy) or exit the hand early for $4.80, locking in a loss of $5.20.
Possible outcome 3: if the player whose hand totals 14 against a dealer 10 elects Next Play and he is dealt a 10 (new total=24), he will have gone over 21 and ‘Busted.’ The hand no longer can win and has an expected value of 0 (zero). In this case, the player loses his entire wager, $10.

Generalizing the above example: As long as the players hand is 21 or below, the player can elect to continue playing the hand vs. the dealer (Next Play) or exit the hand early (Early Payout). During the play of the hand, the hand can improve or worsen, effecting the subsequent Early Payout values each time. The play for the player continues until i) He elects to take Early Payout; ii) The Next Play=Stand and he does not take EP (he chooses Next Play); or iii) The hand Busts (goes over 21) in which case the player loses his wager. Note, even if the player elects EP, the hand continues to deal in accordance with Basic Strategy rules until the Next Play=Stand or it Busts (in the event that other players are still playing the hand, see below).

This is an important feature of Basic Strategy-type embodiments, such as BSBJEP, in comparison to Standard BJ. In particular, more than one player can play the exact same hand with different outcomes, depending on whether (and at what stage) each player elects to take EP.

Continuing the first example above, three different players could have each followed the unique paths above with the following outcomes. Player 1 could take EP of $5.80 before drawing any cards beyond his initial 14, locking in a loss of $4.20 but eliminating his risk of busting on the next card. Player 2 stayed in the hand and drew a 6, for a new total of 20 and then elected to take EP of $15.10, locking in a win of $5.10. Player 3 stayed in the hand and drew a 6 for a new total of 20 and decided not to take EP (play the hand). If the dealer ended up with 19, the player would win his entire bet (Payout=20−10, profit 10).

A significant implication of embodiments allowing multiple players to play the same cards/hand/position with different outcomes is the ability to scale the game (one dealer, virtually unlimited players—subject to network bandwidth limitations rather than game playability or physical limitations in a live casino) can exist, while this is impossible with standard BJ. The reason for this is that players in, for example, BSBJEP decide whether or not to carry on playing a hand or taking EP, not whether they HIT or STAND. As illustrated in the above examples, sometimes it is better to play the hand to its conclusion (those time the players hand ultimately beats the dealer) and there are other times when it is better to take EP (when the players hand ultimately loses, either buy busting or losing by lower count). In every case of BSBJEP, the dealer deals the cards to the player positions by the predetermined rules (Basic Strategy), for ALL players who may have wagered on it.

In standard BJ, both online and at casinos, two players cannot play the same hand with different outcomes. The hand must be played to completion and it will either win, lose or push. One player cannot say he will STAND while another player elects to HIT at the same player position. In other known versions of BJ at this time, each player making play decisions has a 1:1 relationship with the dealer. If a table (online or live) in known games seats 7 players, the 8^{th} player will either have to wait until someone leaves or the casino will need to open another table or, in some casinos where it is allowed, will need to ‘back bet’ behind another player. With Basic Strategy embodiments, such as BSBJEP, one dealer can deal to a potentially a virtually unlimited number of players at the same time as described above. The potential economies of scale with BSBJEP are enormous, especially in the on-line application of the game.

Applying BSBJEP (and Other Casino Games with EP) in a Tournament Format

It is envisioned that a particular tournament format would appeal to players who enjoy this style of player to player competition (as opposed to player against casino play) as is commonplace today in online Poker Rooms. In a preferred embodiment, there is a basic format for the preferred tournament wager. Under this basic format, the tournament involves 2-10 players at a time (but may alternatively involve many more players, such as hundreds of players). Each player pays the same amount to join the tournament (entrance fee). The proceeds of all the player's entrance fees constitute a ‘pot’ that will be distributed at the end of the game to the winner, and potentially 2^{nd}, 3^{rd}, etc. places (less a house commission). This type of game is referred as Player to Player as opposed to Player vs. Casino. The live or online casino operating a tournament game is merely facilitating the play in exchange for a fee, typically around 10% of the entrance fee.

For example, 6 players may join a tournament for $20 plus a $2 fee each making a pot of $120. The ‘house’ in this example takes $12 for running the game and the remaining $120 will be distributed to the winner, perhaps $80 to 1^{st} Place and $40 to 2^{nd} place.

Each player begins the tournament with the same amount of chips or ‘credits.’ The tournament ends when a winner is determined either by: i) all other players having zero credits left; or ii) some other way predetermined way, including for example: a) a specific length of time (e.g. 20 minutes from the start); or b) playing a certain number of hands (or rounds). Unlike tradition live or online poker tournaments, in one embodiment, players to not take each other's chips during play. Therefore, the winner of the tournament is determined by rank (number of total chips at the end), not necessarily by virtue of his opponents having no chips left.

In one alternative embodiment, the tournament format may be advantageously applied to BSBJEP. Due to the feature that multiple players can play the exact SAME CARDS with DIFFERENT outcomes, a BSBJEP tournament is implemented where, for example, 2-10 (or more) players can opt into the tournament with the goal of scoring the highest amount of credits against each other in a predetermined amount of time (or hands). Each player may start with the predetermined amount of credits. Each player would determine what wager to make in any round of the game:
1. which hands to bet on
2. how much to wager on each hand
   For each hand that the player wagered on, he would have the same choices as non-tournament BSBJEP: i) to carry on playing Basic Strategy; or ii) to accept Early Payout. As players make different elections both on size of wager and game play, they will separate themselves from one another, even though they have all had the opportunity to play the EXACT SAME cards, and be offered the EXACT SAME Early Payout values (proportional to their wagers). This type of game play enhances those areas where the players can affect their outcome (wager size and early payout decision) and de-emphasizes the luck of the cards dealt. In one embodiment, the players may be offered a user interface whereby they can see each others scores, but not their bets/plays. Other Player to Player (P2P) functionality may also be used, such as chat.

Texas Hold 'em Bonus with Early Payout has the same playability features and elements as BSBPEP. Once again, wager and decision to take Early Payout or not outweigh the luck of the cards because all players in the tournament play the same cards.

The tournament format described herein may provide the additional advantage of making the game a test of skill. For example, in a preferred tournament embodiment, the dealer deals to only one player position and a dealer position. All tournament players make decisions, including wagers, based on the hand that is dealt to the player position. Because different players have the opportunity to play the exact same cards, for example, to different outcomes, as described above in connection with Texas Hold 'Em and Blackjack, the differentiating factor will be the players' decision making, including wagering strategy.

Implementation alternatives of BSBJEP (and BJEP)

BSBJEP, and the other embodiments (as noted above), can be implemented in either on-line or live, traditional venues, such as casinos.

Online BSBJEP

One or more hands can be dealt at a time (per game). An online player can elect to wager on any or all of the hands that are dealt to the player positions. The dealer can either be live (dealing from a card shoe with built in card scanner with results broadcast via Game Server) or the came can be dealt automatically using a Random Number Generator (RNG) algorithm. Two cards, both face up, are dealt to each player and one up card it dealt to the dealer. In turn, each hand that is dealt is played to its Basic Strategy conclusion (either it ends up Standing or it Busts). A player with a wager on a hand will play his hand as he wishes, either playing the hand to its final outcome or elected EP at an earlier stage. If the player has wagered on more than one hand, he follows the same process for each hand. This may also apply to certain special hands such as split hands.

If more than one remote player has wagered on the same hand, each player independently makes the decisions on how to play the hand (either via BS or to take EP). The system keeps track of each players wager amount and play decision independently. The system calculates the EP value for each player and displays it on a user interface based on the wager amount and the expected value of the hand including the house ‘edge,’ such as from a lookup table. As cards are dealt, the players may be presented with a ‘countdown timer’ to make a decision within a predetermined period, such as xx seconds. If the player does not elect EP in xx seconds, the default condition is to carry on playing the hand, e.g. in accordance with Basic Strategy (i.e., not accept EP). This optional timer feature has the advantage of controlling the pace of the game. For example, the game pace may be set to move quite swiftly (around 5 seconds decision time at each new state).

The dealer/system continues to deal all player hands to completion under, for example, Basic Strategy rules. The system keeps track of which players have elected to take EP and for how much. Completion means dealing until the hand ‘stands’ or ‘busts.’ The dealer/system deals the dealer's cards per standard BJ rules. Upon completion of the dealer's hand, the system automatically disperses funds back in to player accounts for those hands that Player WINS or Player elects EP. In one alternative, the players who remain in a hand while the dealer is completing his hand, could continue to see their EP values change as the dealers hand evolves (states change). For example, standard BSBJEP may show a value of $15.20 if the player has a 20 and the dealer is showing a 10. However, if the dealer turns over a 6 (new total 16, and must still draw another card), the players expectation of winning is much higher, and hence, he could be offered an even higher EP during the dealer's play, prior to completion of the dealers hand. In the embodiments described above, however, EP in BSBJEP stops when the player's hand is complete and BEFORE the dealer plays his hand. This is because of the possibility that this level of complexity/choice will not further enhance the game.

Example On-Line Blackjack Early Payout (BJEP) Architecture in an Internet Environment

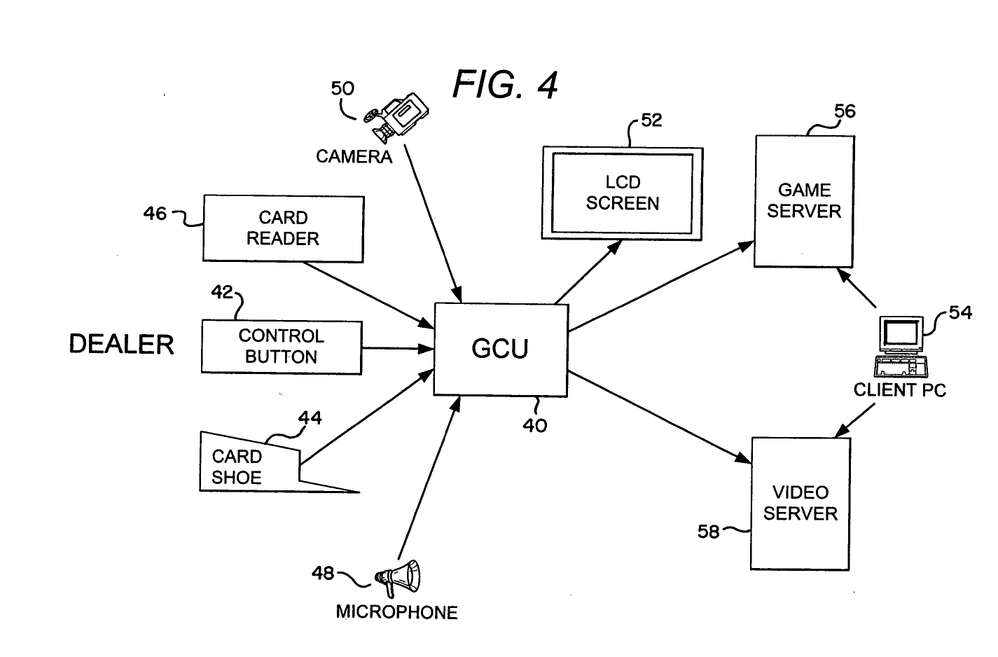

FIG. 4 is a schematic drawing of one embodiment of a system in which the gaming methods described herein may be implemented. The system includes a game control unit (“GCU”) 40, which receives inputs from a dealer button 42, a card shoe 44/automated card reader 46, a microphone 48 and a video camera 50. The GCU 40 is coupled to a dealer monitor 52, which may be an LCD screen. A game client 54 is illustrated as a client PC, although any type of remote computing device may serve as a game client 54. The system also includes a game server 56 and a video server 58, both of which are coupled to the game client 54 and the GCU 40. The GCU 40 and game client 54 are preferably connected by a data/video network to the game server 56 and video server 58. The network connections may be a Local Area Network, although for the on-line embodiments, the game client is typically connected to the game server and the video server via the Internet. Any other suitable network may alternatively be used.

The hardware components shown in FIG. 4, including the GCU 40, game server 56, camera/s 50, microphone 48, etc. and the delivery and presentation of gambling services and results via a network are known to those skilled in the art. The functionality offered by the game server 56 and game client 54 in connection with the preferred embodiments are described throughout herein.

The GCU 40 may be an embedded computer, which is programmed to control the flow of the game, encode video and audio signals, and control switching of video camera/s. The video camera 50 showing the gaming table and/or dealer may be a PTZ camera, which also may be controlled by the GCU 40. The GCU 40 may be coupled to various peripherals, including video encoding card (not illustrated) and cameras 50, and the microphone 48. In this embodiment, The GCU 40 reads video and audio from the media devices (sound device 48, and video encoding card) and encodes these into a digital “stream,” and provides a server to serve these streams to any client or relay that wishes to receive these.

The game state may be controlled, in part, by the dealer button 42, which may be used to signal the start of a game to the GCU 40. The GCU 40 detects the use of this button 42, and begins a game cycle. Thereafter, subsequent game states may be determined from the draw of cards from the card shoe 44. In a preferred embodiment, the card shoe 44 includes an automated card scanner 46, which determines the value of each card drawn, and sends this information to the GCU 40. Automated card scanners 46 are known in the industry, such as the automated card scanners offered by Shuffle Master, Inc. of Las Vegas, Nev., which is suitable for this purpose.

The GCU 40 is programmed to know the correct number of hands to be drawn, and the number of cards to be drawn for each hand. The GCU 40 sends the game state information to the Game Server 56, such as via network connection. In accordance with another preferred embodiment, the GCU 40 may also display game state information to the Dealer Monitor/display 52, to assist the dealer in the correct play of the game.

The Game Server 56 may manage all game client 54 activity, recording of game information and results, and calculation/lookup of EP values to be presented to players. The game client 54 may be a presentation level application which guides the player in the execution of the game, by presenting simulated cards in simulated table positions, which are, in accordance with one embodiment, determined by the actual cards being drawn at the live table, and delivered by the GCU 40 and Game Server 56. The game client 54 also may include a decoder to receive audio and video streams from the GCU 40 or via an intermediate video relay device 58, to display the live action of the game, e.g., dealer and cards, to the client.

Architecture in a Live Environment

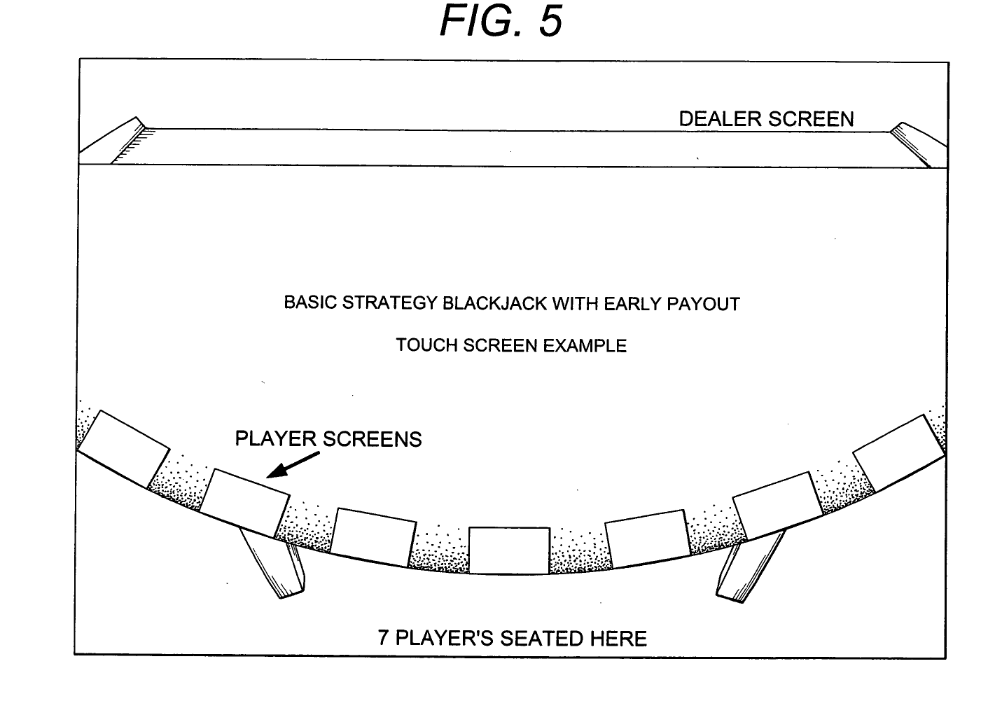

The same general architecture shown in FIG. 4 may be utilized for a live environment, except that the game client 54 PC will be locally located, as opposed to remote, and its functionality may be incorporated into a gaming table, for example as illustrated in FIG. 5. In the example of FIG. 5, the game table includes a touch screen monitor at each player position and another monitor for the dealer position. For implementation in a live environment, e.g. an in-casino environment, additional devices may be added such as a smart-card and smart-card reader. Because of the nature of the game, payments might be odd amounts that make it impractical to pay with traditional chips in a live casino. The player, in this case, might be presented with a touch-screen monitor or other display device located at the gaming table that allows him to make play decisions and maintain his balance, only cashing out when he is ready leave the table (similar to that of an electronic slot machine cashout). Alternatively, the casino may utilize smart chip technology, such as RFID in the casino chips, which may then provide information, such as the amount wagered by the player, to the GCU 40.

Dealer Monitor Hand Sequence

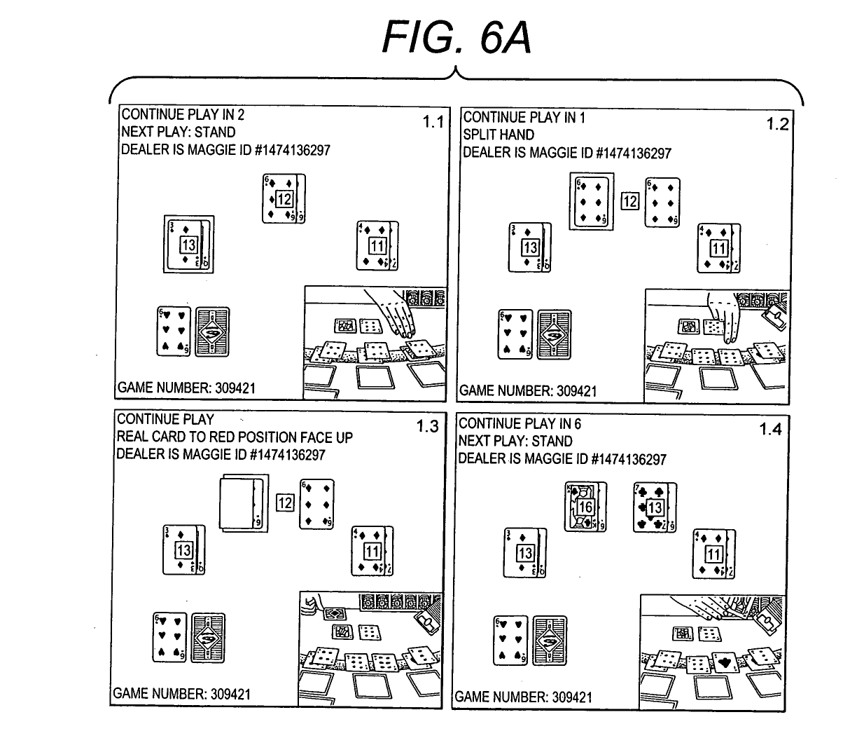

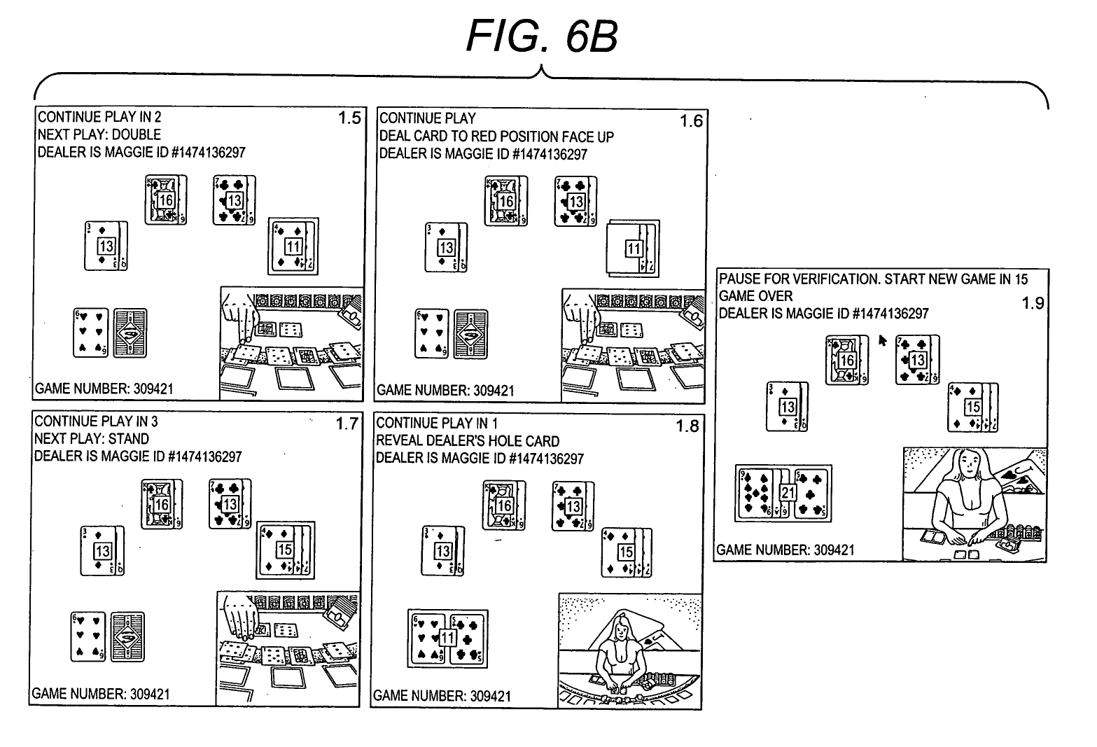

In either the on-line or live environment, embodiments that utilize a dealer will benefit from the use of a dealer monitor. The dealer monitor is a tool for helping the dealer deal the game, such as Basic Strategy Blackjack with Early Payout. The functions of the dealer monitor are illustrated in the dealer monitor screen shots collected in FIG. 6 and described below.

Dealing Sequence

As referenced above, the dealer may push a dealer button 42, also referred to as a ‘New Game’ button, to start a new game cycle. In a preferred embodiment of Basic Strategy Blackjack with Early Payout, the dealer deals three (3) player hands (i.e. hands to three player positions) and a dealer hand, by dealing two face up cards to each player position and one down and then one up card to the dealer position on the game table. Of course, other numbers of player hands may alternatively be dealt. In this embodiment, the game play rotates from Hand 1 to 3, clockwise, starting on the dealer's left, as illustrated in the dealer monitor screen shots show in FIG. 6 (see Photo 1.1). A Yellow Box may be displayed over the cards in the dealer monitor 52 to indicate the hand in play to the dealer.

A countdown timer is preferably utilized in this embodiment to tell the dealer when the next play is to occur (“continue play in X”). The timer corresponds to a countdown timer on the game client 54. This pre-set time gives the player a chance to elect to take Early Payout. The Basic Strategy Next Play is revealed to the Dealer to prepare (HIT, STAND, DOULE, SPLIT). For hand 1 at the first player position, the dealer monitor in Photo 1.1 indicates that the next play is “stand.” Other special commands may be presented to the dealer as well. For example, if the dealer is showing an ace, the dealer monitor may prompt the dealer to announce his card and offer insurance and/or early payout. In hand 1, the Basic Strategy is to STAND and the dealer moves on to the next player hand.

Hand 2 (Photos 1.2, 1.3, 1.4) is an example of a hand that is meant to SPLIT per Basic Strategy. The dealer monitor prompts the dealer that the Next Play is a SPLIT, in the upper left corner of in Photo 1.2 and to deal then the next card to the first 6 (yellow box may be displayed over first 6) when the timer is up. When the timer expires, the dealer monitor in this example displays a RED box where the next card is meant to be dealt (Photo 1.3) to prompt the dealer's next action. After dealing a King, the Next Play per Basic Strategy is STAND and the dealer moves on to the 2^{nd} split hand (photo 1.4).

Hand 3 (Photos 1.5, 1.6, 1.7) is an example of a hand that is meant to DOUBLE per Basic Strategy. Photo 1.5 in FIG. 6B of the dealer monitor prompts the dealer, in the upper left corner, that the Next Play is a DOUBLE and highlights the hand in Yellow (not shown), letting her know that is the ‘active’ hand. In Photo 1.6, the dealer monitor prompts the dealer to deal a card face up to Hand 3 where the RED box is shown. In Photo 1.7, the dealer monitor prompts the dealer that Next Play per Basic Strategy is STAND (you can only take one card on a Double) and runs a timer to allow the player time to accept Early Payout if he so chooses.

The Dealer Hand is shown in Photos 1.8 and 1.9 of the dealer monitor. At the appropriate time, the dealer monitor prompts the dealer to reveal the “hole card.” Then, depending on the value of the dealer hand and Blackjack dealer rules (in the case of Atlantic City BJ rules, the dealer must hit on 16 or less, stand on 17 or more), the dealer with either hit again or the hand will be over because the dealer reached 17 or more or the dealer ‘busted’ (went over 21). In this case, the dealer has 11 after two cards and must HIT again per casino rules. The dealer draws a ACE for 12, draws again per Basic Strategy, and then receives a 9 for total 21 (HIT sequence not shown, but in a preferred embodiment, would have revealed a RED box on the dealer cards for each hit required to be dealt).

When the hand is complete, Photo 1.9 in FIG. 6B, the dealer monitor instructs the dealer to stop (“game over”) while the camera focuses in on the final hand, pausing for verification. Finally, the dealer monitor tells the dealer that the Game (hand) is over. The dealer monitor will then flash a cue to say “PLACE YOUR BETS” while the dealer sweeps the cards from the previous hand. The dealer will push the dealer button to initiate a new game, and the dealer monitor will cue the dealer to say “NO MORE BETS” and the entire sequence begins again with 3 more player hands and a dealer hand.

Texas Hold'Em With Early Payout

There are many other games that could have Early Payout added to them to make them more exciting and/or to improve playability. One example is Texas Hold'em Bonus. Although the permutations of Poker hands are far more than BJ, the odds of winning or losing can nonetheless be calculated for each and every possible hand combination, consistent with the invention.

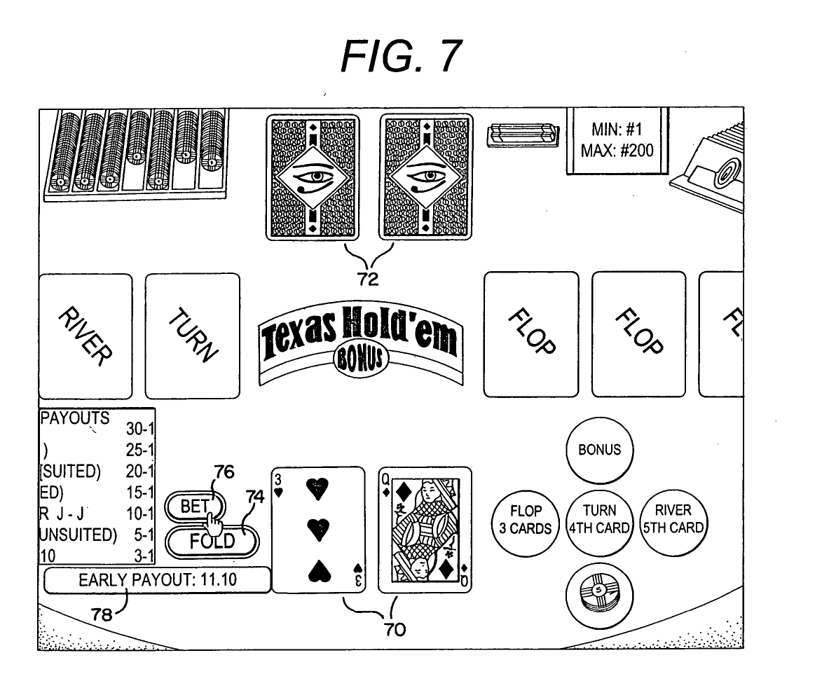

FIG. 7 shows an initial deal for Texas Hold'em Bonus with Early Payout in accordance with a preferred embodiment. Two cards have been dealt to the player position 70, and two cards to the dealer position 72. Normally, the player can elect to FOLD 74 or to BET 76 the flop. Adding Early Payout 78 to this game, the player can have a 3^{rd} choice: Take Early Payout 78 and end the game immediately. In the example illustrated, the player has a queen which is slightly positive and therefore the player is given the opportunity to exit the hand for a small profit (i.e. Early Payout of 11.10 with an initial wager of 10)

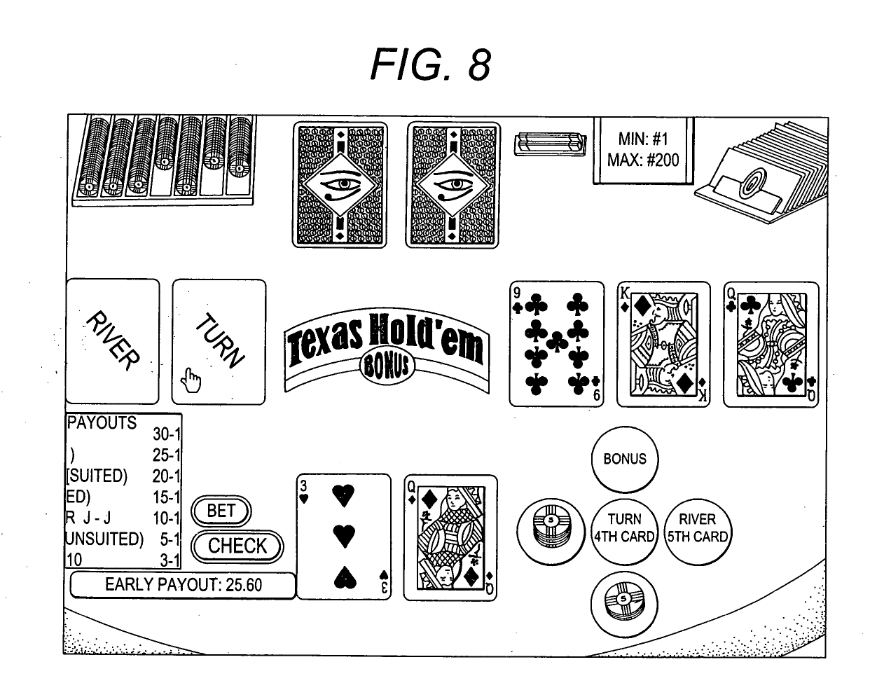

If the Player does NOT elect to take EP, then the game carries on to the next state as shown in FIG. 8. In this example, the player has wagered an additional $20 to ‘see the flop,’ which is shown as 9, King, Queen. The player is fortunate enough to pair his queens. The system determines a new expectation of his outcome, and the player is now offered a new EP value. Again, he can choose to take the EP payment and end the hand immediately or to carry on playing as in the standard way.

For any of the embodiments described above, the game may be implemented with a decision timer to facilitate not only implementation of Basic Strategy, but also to improve playability by keeping the game moving. The decision timer provides a player with a predetermined time to make a decision, and if the player does not provide a response, then the game proceed in accordance with a default response. For example, if at an intermediate state in the course of the game, the player is offered early payout, but does not respond, then the method may proceed as if the player declined early payout. Alternatively, of course, the method may proceed as if the player accepted early payout. The decision timer may also be applied to the setting of the initial wager or other aspects of the game—e.g., if a player completes a hand and does nothing to alter his or her initial wager within the predetermined time, the game may proceed with the player wagering the same amount as previously set.

As described above, a known game of chance or skill may be modified in accordance with the preferred embodiments to provide advantages in terms of playability, while at the same time providing the dealer/house/casino an opportunity to improve its position. In terms of playability, the preferred embodiments provide the player with additional alternative outcomes and decision points, which may allow the player to more actively manage his or her wager and provides additional participation opportunities. In addition, as noted above, the Basic Strategy embodiments allow more than one player to participate in the game at any one player “position.” From the perspective of the dealer/house/casino, flexibility in setting the Early Payout amount provides an opportunity to improve its position in comparison to the basic game.

I claim:

1. A method of playing an on-line game, comprising:
a) presenting players with an opportunity to select a virtual playing position, where the game will allow more than one player at each virtual playing position;
b) dealing the game to each virtual playing position according to an optimal choice playing strategy for the game;
c) presenting each player, at at least one game state, with a choice between continuing to play the hand according to the optimal choice playing strategy and taking an alternative position; and
d) continuing to deal the game to each virtual playing position according to the optimal choice playing strategy for the game regardless of the choice selected by any player.

2. The method of claim 1, wherein the alternative position comprises an offer of early payout.

3. The method of claim 2, wherein an offer of early payout is made at each game state during the game.

4. The method of claim 1, wherein the game is a Basic Strategy Blackjack game.

5. The method of claim 1, wherein the game is a casino poker game.

6. The method of claim 1, further comprising providing a predetermined period of time during which the choice is presented and a default choice when no player response is received within the predetermined period of time.

7. The method of claim 1, wherein the game is a tournament game.

8. The method of claim 7, wherein the tournament game is played among a predetermined number of players and wherein more than one player is playing the same virtual playing position.

9. The method of claim 8, wherein all players play the same virtual playing position.

10. The method of claim 7, wherein the tournament is played among a predetermined number of players and wherein all of the players may choose to play any of the virtual playing positions.

11. A method of playing a game, comprising:
a) dealing a first round of the game, each player position receiving an initial hand in the first round;
b) determining an expected value for each initial hand;
c) offering each player position an early payout amount based on the expected value for each initial hand;
d) continuing to deal the game; and
e) for each subsequent game state, again offering an early payout amount based on the current expected value for each hand being played.

12. The method of claim 11, wherein the dealing step is performed by a dealer in a live casino environment.

13. The method of claim 1 1, wherein the dealing step is performed by a dealer in an on-line environment.

14. The method of claim 11, wherein the dealing step is performed by a random number generating device.

15. The method of claim 11, wherein the dealing step comprises dealing the game to each playing position according to an optimal choice playing strategy for the game.

16. The method of claim 15, wherein more than one player is allowed to occupy each playing position.

17. The method of claim 15 wherein the game is a Basic Strategy Blackjack game.

18. The method of claim 11, wherein the game is a casino poker game.

19. The method of claim 11, wherein the game is baccarat.

20. The method of claim 11, wherein the game is punto banco.

21. The method of claim 11, wherein the game is a tournament game.

22. The method of claim 21, wherein the tournament game is played among a predetermined number of players and wherein all of the players may choose to play any one or more of the playing positions.

23. A system for allowing a plurality of players to play a game, comprising
a) a game server, the game server including a set of instructions for playing the game, wherein the set of instructions includes instructions for dealing a game according to an optimal choice playing strategy and instructions for determining an alternative position for presentation to the players, the alternative position being an alternative to continuing the game in accordance with the optimal choice playing strategy;
b) at least one game client coupled to the game server; and
c) at least one user interface coupled to the game client, the user interface presenting information to the players and receiving inputs from the players.

24. The system of claim 23, further comprising:
a) a video feed coupled to the game server;
b) an audio feed coupled to the game server; and
c) an automated card scanner coupled to the game server,
d) whereby the players interact with a live dealer during the game.

25. The system of claim 23, wherein the alternative position comprises an offer of early payout.

26. The system of claim 23, wherein the information presented on the user interface comprises a next step in accordance with the optimal choice playing strategy and an offer of early payout.

27. The system of claim 23, wherein the game client and game server are connected via a network.

28. The system of claim 23, wherein the game client is coupled to the game server via the Internet.
